(19) United States
(12) Patent Application Publication
(10) Pub. No.: US 2024/0255955 A1
(43) Pub. Date: Aug. 1, 2024

(54) INSPECTION WORK ASSISTANCE APPARATUS AND INSPECTION WORK ASSISTANCE METHOD

(71) Applicant: Mitsubishi Electric Corporation, Tokyo (JP)

(72) Inventors: Yosuke NAKAYAMA, Tokyo (JP); Hiroe TAKENAGA, Tokyo (JP); Ai KOSHI, Tokyo (JP); Shuhei FUJITA, Tokyo (JP); Nobutoshi TODOROKI, Tokyo (JP)

(73) Assignee: Mitsubishi Electric Corporation, Tokyo (JP)

(21) Appl. No.: 18/290,896

(22) PCT Filed: Jul. 28, 2021
(86) PCT No.: PCT/JP2021/027907

§ 371 Date: Jan. 22, 2024

(51) Int. Cl. G05D 1/243; G05D 1/223; G05D 105/80; G06F 3/01; G06T 19/00

(52) U.S. Cl. CPC G05D 1/243; G05D 1/223; G06F 3/011; G06T 19/006; G05D 2105/89

(57) ABSTRACT

An object is to provide a technique to provide appropriate assistance for inspection work. An inspection work assistance apparatus includes a determination unit, an extraction unit, and a route creation unit. The determination unit determines whether any of the plurality of devices subject to inspection is a device with abnormality based on the inspection result. The extraction unit extracts an additional device for inspection related to the device with abnormality from the plurality of devices based on the related information related information that allows the plurality of devices to be related. The creation unit creates an inspection route passing through at least one of the plurality of devices subject to inspection and the additional device for inspection.

### TECHNICAL FIELD

The present disclosure relates to an inspection work assistance apparatus and an inspection work assistance method.

### BACKGROUND ART

In large-scale facilities such as power plants, regular patrol inspection work is carried out by inspectors for the purpose of maintaining devices in a plant, where an enormous amount of time is consumed on inspection work such as the patrol inspection work (which hereinafter may be described as “inspection” for short). When inspecting, an inspection route passing through a device for inspection, which is a device subject to inspection in an appropriate order, is required to be created. However, creating an inspection route largely depends on the experience and intuition of an inspector, and it is difficult for an unskilled inspector to create an efficient inspection route. In addition, the device subject to inspection is determined from an inspection plan based on information such as inspection cycle, inspection history, failure history, and not all the devices are thoroughly inspected in a single round of inspection.

Therefore, various techniques have been proposed or implemented for efficient inspection. For example, a solution is taking hold that enhances efficiency of inspection, with an inspector, who is holding a portable communication device such as a tablet or a Head Mounted Display (HMD), inputting inspection results into the communication device.

Also, for example, Patent Document 1 discloses a technique that, at the start of inspection, extracts devices subject to inspection based on an inspection cycle and inspection start time of all possible devices for devices subject to inspection, creates an inspection route that passes through all of the devices, and displays the inspection route and a map on a spectacle device. According to the technique, efficient inspection can be conducted by the inspector checking the automatically generated inspection route.

Also, for example, Patent Document 2 discloses a technique that assists in determining whether to conduct additional inspection on devices during the inspection process by presenting the probability of damage to devices to the inspector using inspection results obtained during the inspection. According to the technique, assistance to making a decision to conduct additional inspection on the devices under the inspection process is enabled.

Patent Document 3 discloses a technique for conducting a related investigation of a device determined to be abnormal, based on an abnormality identified during the inspection, according to predetermined measures described in a database prepared in advance. According to the technology, quick investigation and imminent treatment can be given to the device in the inspection process.

### PRIOR ART DOCUMENTS

### Patent Document(s)

[Patent Document 1] Japanese Patent Application Laid-Open No. 2008-171086
[Patent Document 2] Japanese Patent Application Laid-Open No. 2020-113229
[Patent Document 3] Japanese Patent Application Laid-Open No. H3-222639

### SUMMARY

### Problem to be Solved by the Invention

However, in the conventional techniques, when an abnormality is determined in a device in the inspection process, additional inspection is viable on the device in itself, but a new inspection route is not created with devices related to the device added to inspection subjects. For this reason, there remains a problem that appropriate assistance for appropriate inspection work is not provided.

The present disclosure has been made in view of the above problem and has an object to provide a technique to provide appropriate assistance for inspection work.

### Means to Solve the Problem

According to the present disclosure, an inspection work assistance apparatus configured to assist inspection work in a plant, includes an acquisition unit configured to acquire an inspection result of any of a plurality of devices subject to inspection through which a first inspection route passes among a plurality of devices in the plant, a determination unit configured to determine whether any of the plurality of devices subject to inspection is a device with abnormality based on the inspection result, an extraction unit configured to extract an additional device for inspection related to the device with abnormality from the plurality of devices based on related information that allows the plurality of devices to be related, and a route creation unit configured to create a second inspection route passing through at least one of the plurality of devices subject to inspection and the additional device for inspection.

### Effects of the Invention

According to the present disclosure, an additional device for inspection related to the device with abnormality is extracted and an inspection route that passes through at least one of the plurality of devices subject to inspection and the additional device for inspection is created. According to such a configuration, appropriate assistance for inspection work is enabled.

The purpose, feature, phase, and advantage of the present disclosure will become more apparent from the following description and the accompanying drawings.

### BRIEF DESCRIPTION OF DRAWINGS

FIG. 1 A block diagram illustrating a configuration of an inspection work assistance apparatus according to Embodiment 1.

FIG. 2 A flowchart illustrating an outline of a processing procedure of the inspection work assistance apparatus according to Embodiment 1.

FIG. 3 A table illustrating an example of an operating history.

FIG. 4 A table illustrating an example of device information.

FIG. 5 A table illustrating an example of an inspection history.

FIG. 6 A table illustrating an example of an inspection schedule.

FIG. 7 A diagram illustrating an example of plant structure information.

FIG. 8 A table illustrating an example of plant structure information.

FIG. 9 A flowchart illustrating a processing procedure of a route construction unit according to Embodiment 1.

FIG. 10 A flowchart illustrating a processing procedure of a measurement diagnostic unit according to Embodiment 1.

FIG. 11 A flowchart illustrating a processing procedure of an additional device for inspection extraction unit according to Embodiment 1.

FIG. 12 A block diagram illustrating a hardware configuration of an inspection work assistance apparatus according to Embodiment 1.

FIG. 13 A block diagram illustrating a configuration of a network configuration of the inspection work assistance apparatus according to Embodiment 1.

FIG. 14 A block diagram illustrating a configuration of an inspection work assistance apparatus according to Embodiment 2.

FIG. 15 A flowchart illustrating a processing procedure of an additional device for inspection extraction unit according to Embodiment 2.

FIG. 16 A block diagram illustrating a configuration of an inspection work assistance apparatus according to Embodiment 3.

FIG. 17 A flowchart illustrating a processing procedure of a route construction unit according to Embodiment 3.

FIG. 18 A block diagram illustrating a configuration of an inspection work assistance apparatus according to Embodiment 4.

FIG. 19 A diagram illustrating a display example of the inspection work assistance apparatus according to Embodiment 4.

FIG. 20 A block diagram illustrating a configuration of an inspection work assistance apparatus according to Embodiment 5.

FIG. 21 A block diagram illustrating an example of display screen of the inspection work assistance apparatus according to Embodiment 5.

### DESCRIPTION OF EMBODIMENT(S)

### Embodiment 1

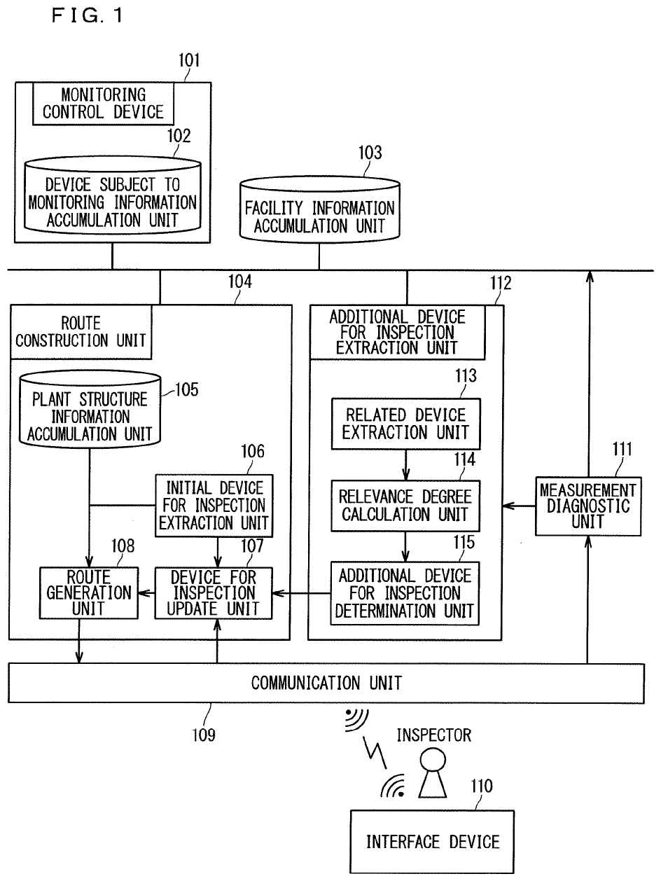

FIG. 1 is a block diagram illustrating a configuration of an inspection work assistance apparatus according to Embodiment 1. The inspection work assistance apparatus in FIG. 1 includes a device subject to monitoring information accumulation unit 102, a facility information accumulation unit 103, a route construction unit 104, which is a route creation unit, a communication unit 109 and an interface device 110 which are acquisition units, a measurement diagnostic unit 111, which is a determination unit, and an additional device for inspection extraction unit 112, which is an extraction unit.

The route construction unit 104 includes a plant structure information accumulation unit 105, an initial device for inspection extraction unit 106, a device for inspection update unit 107, and a route generation unit 108. The additional device for inspection extraction unit 112 includes a related device extraction unit 113, a related degree calculation unit 114, and an additional device for inspection determination unit 115.

First, an outline of the inspection work assistance apparatus will be described. The inspection work assistance apparatus is an apparatus that assists inspection work such as patrol inspection work (which hereinafter may be described as “inspection” for short) in a plant. The inspection work assistance apparatus in FIG. 1 acquires an inspection result for any of a plurality of devices subject to inspection, through which an inspection route (an example of a first inspection route) passes, among a plurality of devices in a facility in a plant. It should be noted that the one inspection route passing through the devices includes the one inspection route passing near the devices so that an inspector can inspect the devices.

The inspection work assistance apparatus diagnoses (determines) whether any of the plurality of devices subject to inspection is a device with abnormality based on the inspection result. Then, the inspection work assistance apparatus of FIG. 1 extracts an additional device for inspection related to the device with abnormality from the plurality of devices in the plant, and creates an inspection route (an example of a second inspection route) that passes through at least one of the plurality of devices subject to inspection and the additional device for inspection. Creating the inspection route as described above enables appropriate inspection work by an inspector.

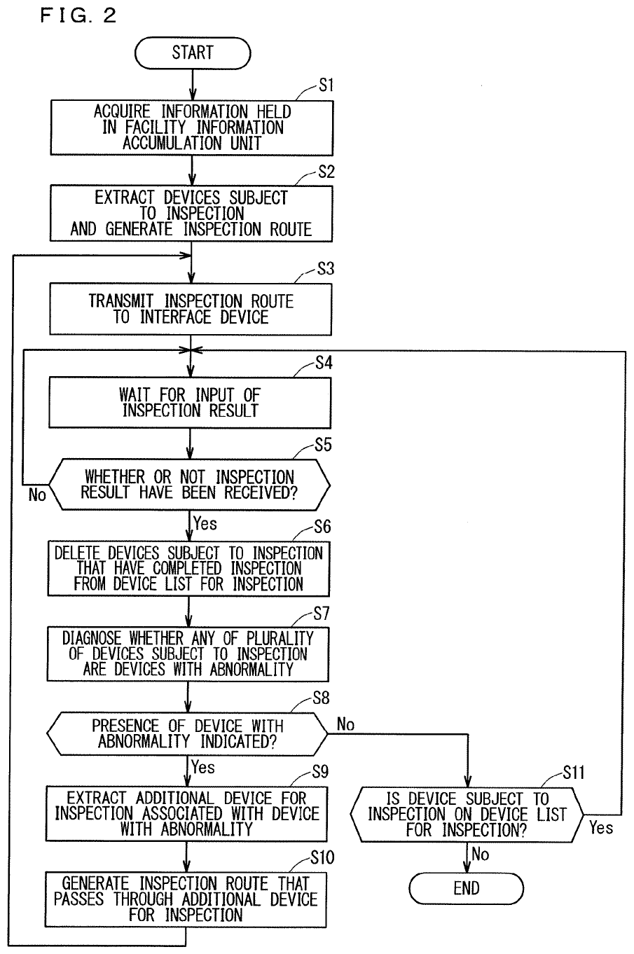

FIG. 2 is a flowchart illustrating an outline of a processing procedure of the inspection work assistance apparatus according to Embodiment 1.

First, in Step S1, the route construction unit 104 acquires information held in the facility information accumulation unit 103.

In Step S2, the initial device for inspection extraction unit 106 in the route construction unit 104 extracts devices subject to inspection being the devices that are subject to inspection from a plurality of devices in the plant based on the information acquired in Step S1, and generates an initial device list for inspection showing the plurality of devices subject to inspection. Note that the initial device list for inspection is a type of device list for inspection representing the plurality of devices subject to inspection, and is a device list for inspection that is generated initially. Hereinafter, when the initial device list for inspection and the device list for inspection are not distinguished, they are collectively described as a device list for inspection.

Based on the information in the plant structure information accumulation unit 105 and the initial device list for inspection, the route generation unit 108 generates an inspection route (an example of the first inspection route) that efficiently passes through the plurality of devices subject to inspection listed on the initial device list for inspection.

In Step S3, the communication unit 109 transmits the generated inspection route to the interface device 110, such as a tablet, held by the inspector who conducts the inspection. When the process of Step S3 is performed immediately after Step S2, the communication unit 109 transmits the inspection route generated in Step S2 to the interface device 110.

In Step S4, the inspection work assistance apparatus enters a standby state waiting for an input of an inspection result for any of the plurality of devices subject to inspection from the inspector.

In Step S5, the interface device 110 determines whether or not the inspection result has been received from the inspector. When determined that the inspection result has been received, the process proceeds to Step S6, and when determined that the inspection result has not been received, the process of Step S5 is re-performed.

In Step S6, the interface device 110 transmits the inspection result received from the inspector to the communication unit 109, and the route construction unit 104 deletes devices, whose inspection result has been received by the communication unit 109, that is, the devices subject to inspection that have completed inspection, from the device list for inspection.

In Step S7, the measurement diagnostic unit 111 diagnoses whether any of the plurality of devices subject to inspection are devices with abnormality based on the inspection result received by the communication unit 109. The measurement diagnostic unit 111 transmits the diagnosis result to the facility information accumulation unit 103 and the additional device for inspection extraction unit 112.

In Step S8, the additional device for inspection extraction unit 112 determines whether the diagnosis result by the measurement diagnostic unit 111 indicates the presence of a device with abnormality. When determined that a device with abnormality is present, the process proceeds to Step S9, and when determined that a device with abnormality is not present, the process proceeds to Step S11.

In Step S9, the additional device for inspection extraction unit 112 acquires the information held in the device subject to monitoring information accumulation unit 102 and the information held in the facility information accumulation unit 103 as related information that allows the plurality of devices in the plant to be related. Then, the additional device for inspection extraction unit 112 extracts an additional device for inspection related to the device with abnormality from the plurality of devices based on the related information. The additional device for inspection extraction unit 112 transmits data on the additional device for inspection and an addition request to the route construction unit 104.

In Step S10, the device for inspection update unit 107 of the route construction unit 104 adds the additional device for inspection to the device list for inspection to create a new device list for inspection, and transmits the new device list for inspection to the route generation unit 108. The route generation unit 108 generates a new inspection route that efficiently passes through the devices on the new device list for inspection, based on the information in the plant structure information accumulation unit 105 and the new device list for inspection. In other words, the route construction unit 104 creates a new inspection route (an example of a second inspection route) that passes through an uninspected device subject to inspection (an example of at least one of a plurality of devices subject to inspection) and the additional device for inspection.

Thereafter, the additional device for inspection added to the device list for inspection is dealt as a device subject to inspection. Then, the process returns to Step S3, and in Step S3, the communication unit 109 transmits the inspection route generated in Step S10 to the interface device 110. The inspector can appropriately inspect devices that require inspection in line with the inspection route that is sequentially changed during the inspection.

In Step S11, the inspection work assistance apparatus determines whether or not the device subject to inspection is on the device list for inspection. When determined that the device subject to inspection is on the device list for inspection, it is determined that the inspection is ongoing, the process returns to Step S4, and in this Step S4, a standby state is entered in which an input of inspection result is to be accepted for any of the plurality of devices subject to inspection. When determined that no device subject to inspection is on the device list for inspection, it is determined that the inspection has been completed, and the process in FIG. 2 ends.

Next, each component of the inspection work assistance apparatus will be described in detail.

### <Device Subject to Monitoring Information Accumulation Unit 102>

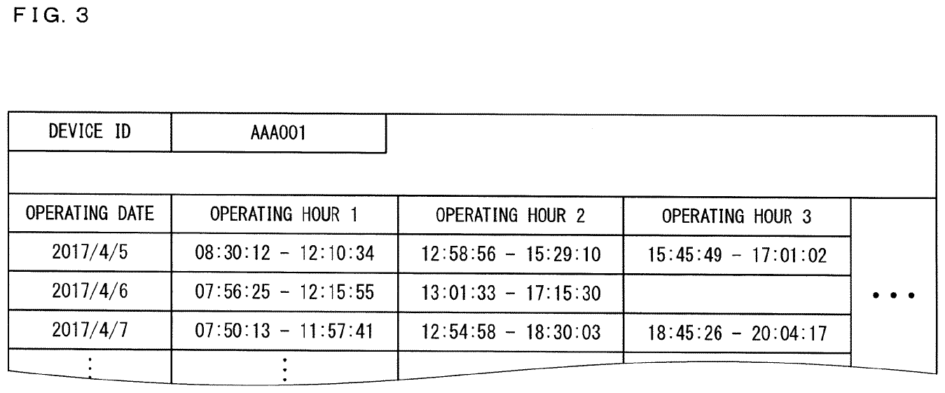

The monitoring control device 101 monitors a device subject to monitoring of a plurality of devices in the plant. The device subject to monitoring information accumulation unit 102 accumulates monitoring control information acquired by the monitoring control device 101. The monitoring control information, being information necessary for monitoring control of the device subject to monitoring, includes, for example, data on operation history representing the operating status of a plurality of devices subject to monitoring and data on dependencies between signals received by the monitoring control device 101 from the plurality of devices subject to monitoring. FIG. 3 is a table illustrating an example of an operating history. The operation history data in the example of FIG. 3 includes operating dates and operating hours of a certain device. Note that in Embodiment 1, although the device subject to monitoring information accumulation unit 102 is included in the monitoring control device 101, the configuration thereof is not limited thereto.

### <Facility Information Accumulation Unit 103>

The facility information accumulation unit 103 accumulates facility information. The facility information includes, for example, device information regarding a plurality of devices and inspection information regarding inspections of the plurality of devices, and the inspection information includes, for example, an inspection history and an inspection schedule. The device information, the inspection history, and the inspection schedule will be described below.

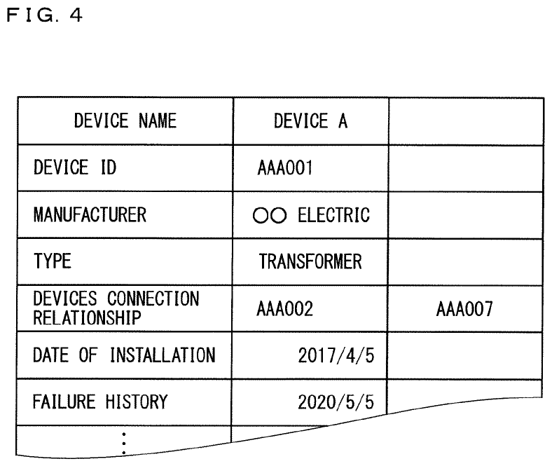

FIG. 4 is a table illustrating an example of the device information. The device information in the example in FIG. 4 includes, for example, device metadata such as a device name, a device ID, a device manufacturer, and a device type, for each device in the facility in the plant, and includes a physical connection relationship and positional relationship between devices, the date of installation, and a failure history. Updateable data such as the date of installation and the failure history are updated as needed, ensuring that the data always reflects the latest data. The device information may include data such as failure prediction based on the failure history of the device provided by the manufacturer.

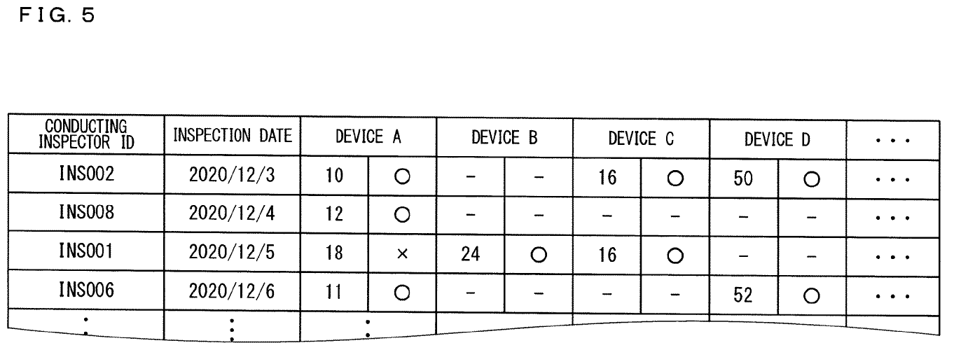

FIG. 5 is a table illustrating an example of the operating history. In the inspection history data in the example of FIG. 5, the inspector who conducted the inspection, the inspection date, and the inspection result of each device are related to each other. Note that the inspection result in the example of FIG. 5 includes measurements obtained during inspection, and an abnormality diagnosis result in which ∘ representing no abnormality and x representing confirmed abnormality are respectively given.

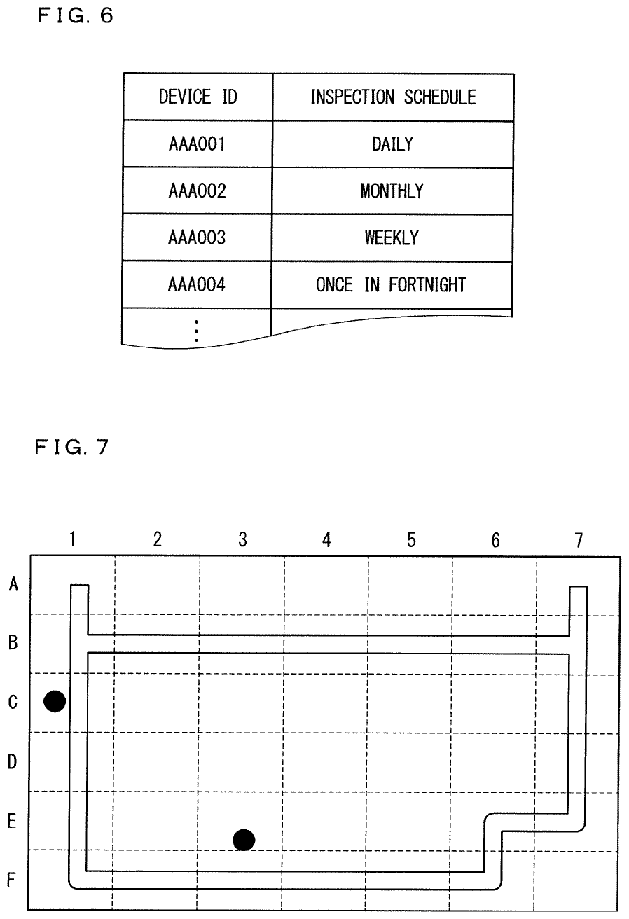

FIG. 6 is a table illustrating an example of the inspection schedule. The inspection schedule data in the example of FIG. 6 represents an inspection schedule that indicates an inspection period defined for each device, that is, the time interval at which inspections should be performed.

The facility information need only just contain the above data about every device in the plant. However, the facility information is not limited to the above, and may include information such as functions roles and the usage environment of a device in the processing flow within the plant. The facility information is transmitted to the route construction unit 104 and the additional device for inspection extraction unit 112 in response to a request. Further, when the measurement diagnostic unit 111 transmits an inspection result for each device, the inspection results are accumulated in the facility information accumulation unit 103 as the facility information.

Note that in Embodiment 1, the monitoring control information accumulated in the device subject to monitoring information accumulation unit 102 and the facility information accumulated in the facility information accumulation unit 103 are used as related information that allows the plurality of devices in the plant to be related but it is not limited thereto. For example, at least part of the monitoring control information or the facility information may be used as the related information.

### <Communication Unit 109>

The communication unit 109 transmits the inspection route created by the route construction unit 104 to the interface device 110 held by the inspector. Further, the communication unit 109 transmits the inspection result transmitted from the interface device 110 held by the inspector to the route construction unit 104 and the measurement diagnostic unit 111.

### <Interface Device 110>

The interface device 110 held by the inspector includes an input device such as a touch panel and a keyboard, a display device such as a liquid crystal display that displays information thereon, and a communication device that establishes wireless communication with the communication unit 109 using, for example, 4G and Bluetooth (registered trademark). For example, a terminal such as a smartphone or a tablet is used as the interface device 110.

The interface device 110 displays the inspection route transmitted from the communication unit 109 to the communication device of the interface device 110 as appropriate, and transmits the inspection result input by the inspector from the communication device of the interface device 110 to the communication unit 109. Note that the interface device 110 may be configured to appropriately display an inspection manual illustrating inspection procedures etc. according to the inspection items, or appropriately output to the storage device so as to be able to store in the storage device of the interface device 110.

### <Route Construction Unit 104>

The route construction unit 104 of FIG. 1 includes the plant structure information accumulation unit 105, the initial device for inspection extraction unit 106, the device for inspection update unit 107, and the route generation unit 108.

The plant structure information accumulation unit 105 holds plant structure information, which is map data in the plant. Plant structure information includes, for example, data in which drawings of a power plant and a factory are sectioned into grids and coordinates are assigned to each section, data that illustrates the installation positions of devices operated in the plant using the coordinates, and data mapped maps such as passages that people can pass through from Computer Aided Design (CAD) data at the time of design. Specifically, the plant structure information includes map data in the plant and data on the positions of a plurality of devices. The plant structure information is transmitted to the route generation unit 108 in response to a request.

FIG. 7 is a diagram illustrating an example of data in which a drawing is sectioned into a grid, which is included in the plant structure information. In the example in FIG. 7, the drawing is sectioned into a plurality of sections with a certain width and height, each section is assigned with, as coordinates, a pair of any numbers 1 to 7, given from left and any of the alphabetic letters A to F given from the above. Note that in the example of FIG. 7, not only a grid for defining coordinates but also two dots indicating two devices, a passage, etc. are mapped. Note that instead of the coordinates in FIG. 7, latitude and longitude may be used as the coordinates, or vertical and horizontal distances from the origin defined in the drawing may be used as the coordinates.

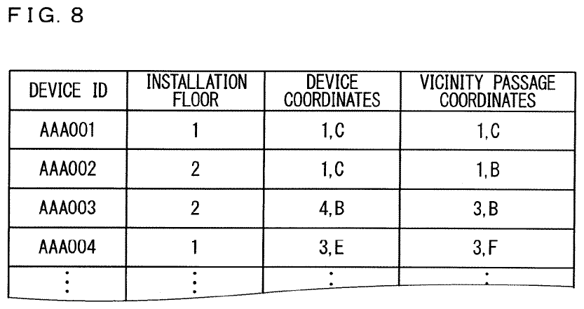

FIG. 8 is a table illustrating an example of data on installation positions of devices, which is included in the plant structure information. In the example in FIG. 8, the plant structure information includes the number of floor levels where each device is installed (that is, the installation floor), the coordinates of the area where each device is installed in the areas where the drawing is sectioned into a grid (that is, the device coordinates), and the coordinates of an area where a passage in which a person can inspect the device is present (that is, vicinity passage coordinates). Note that instead of the coordinates in FIG. 8, latitude and longitude may be used as the coordinates, or vertical and horizontal distances from the origin defined in the drawing may be used as the coordinates.

The initial device for inspection extraction unit 106 acquires the inspection information including the inspection history data illustrated in FIG. 5 and the inspection schedule data illustrated in FIG. 6 from the facility information accumulation unit 103. Then, the initial device for inspection extraction unit 106 extracts a plurality of devices subject to inspection from the plurality of devices in the plant based on the inspection information, and adds them to the initial device list for inspection. For example, when the current date indicates it has been one week or more since the latest inspection date of the device B in FIG. 5, which is set to “AAA003” in FIG. 6 being the device ID of the device B, the initial device for inspection extraction unit 106 adds the device B to the initial device list for inspection as a device subject to inspection. Or, for example, when for some reason the current date has passed the period set for the device in FIG. 6 from the latest inspection date or more of a certain device in FIG. 5, the initial device for inspection extraction unit 106 adds the device to the initial device list for inspection as a device subject to inspection. The initial device for inspection extraction unit 106 transmits the initial device list for inspection to the route generation unit 108 and the device for inspection update unit 107.

The device for inspection update unit 107 updates the device list for inspection such as an initial device list for inspection. For example, when receiving the diagnosis result of a certain device subject to inspection from the measurement diagnostic unit 111, the device for inspection update unit 107 deletes the device subject to inspection from the device list for inspection. Also for example, when receiving a request to add additional device for inspection (that is, an update command) from the additional device for inspection extraction unit 112, the device for inspection update unit 107 updates the device list for inspection by adding the additional device for inspection to the device list for inspection, and transmits the updated device list for inspection to the route generation unit 108. In other words, when there is a request to add a device for inspection, an uninspected device subject to inspection that is at least any one of the plurality of devices subject to inspection and an additional device for inspection are identified in the updated device list for inspection.

Based on either the initial device list for inspection by the initial device for inspection extraction unit 106 or the updated device list for inspection by the device for inspection update unit 107, and the plant structure information, the route generation unit 108 generates an inspection route that efficiently passes through all the devices listed on the list. That is, based on the plant structure information and the extraction result by the initial device for inspection extraction unit 106, the route generation unit 108 generates an inspection route (the example of the first inspection route) that efficiently passes through all the devices subject to inspection listed on the initial device list for inspection. Also, based on the plant structure information and the identification result of the device for inspection update unit 107, the route generation unit 108 generates the inspection route (the example of the second inspection route) that efficiently passes through all the uninspected devices subject to inspection and the additional device for inspection listed on the device list for inspection.

The route generation unit 108 may generate a passage that passes through all the devices listed on the list in the shortest distance, as an inspection route that efficiently passes through all the devices listed on the list. Specifically, the route generation unit 108 may acquire the vicinity passage coordinates of all the devices on the list from the plant structure information and obtain the distance of the passage between each coordinates from the mapping data of the passage to generate the passage with the shortest total distance as the inspection route above.

Note that the route generation unit 108 may determine the starting point of the inspection route based on the current position information of the inspector at the time of generating the inspection route. As the current position information of the inspector at the time of generating the inspection route, a predetermined position such as a central monitoring room or a position where a device required for inspection is installed may be adopted, or a position of a device the most recently inspected may be adopted. When the interface device 110 is equipped with a Global Positioning System (GPS) or the like, the position acquired by the GPS may be adopted as the current position information at the time of generating the inspection route. The route generation unit 108 transmits the generated inspection route to the communication unit 109.

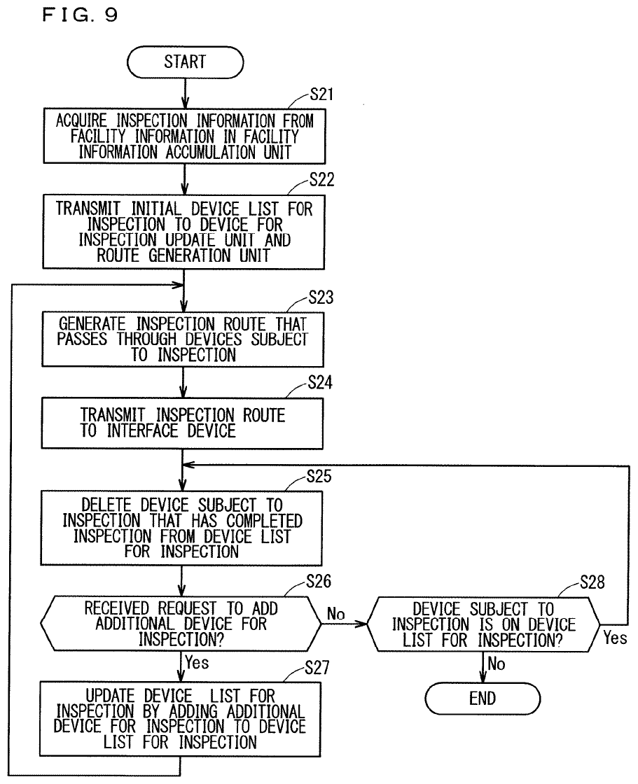

FIG. 9 is a flowchart illustrating a processing procedure to create the inspection route by the route construction unit 104 according to Embodiment 1. The flowchart corresponds to the processes of Steps S1, S2, S3, S6, S10, and S11 in FIG. 2.

First, in Step S21, the initial device for inspection extraction unit106 acquires the inspection information from the facility information in the facility information accumulation unit 103. The process is executed when starting inspection work. The initial device for inspection extraction unit 106 extracts a plurality of devices subject to inspection based on the inspection information, and adds them to the initial device list for inspection.

In Step S22, the initial device for inspection extraction unit 106 transmits the initial device list for inspection to the device for inspection update unit 107 and the route generation unit 108.

In Step S23, the route generation unit 108 generates an inspection route that passes through all the devices subject to inspection listed on the device list for inspection, based on the plant structure information in the plant structure information accumulation unit 105 and the device list for inspection. When the process of Step S23 is performed immediately after Step S21, based on the plant structure information and the initial device list for inspection, the route generation unit 108 generates an inspection route (the example of the first inspection route) that passes through all the devices subject to inspection listed on the device list for inspection.

In Step S24, the communication unit 109 transmits the generated inspection route to the interface device 110 held by the inspector.

In Step S25, the device for inspection update unit 107 deletes the device for which the inspection result has been received by the communication unit 109, that is, the device subject to inspection that has completed inspection, from the device list for inspection.

In Step S26, the device for inspection update unit 107 determines whether or not the device for inspection update unit 107 has received a request to add additional device for inspection from the additional device for inspection extraction unit 112. When determined that the additional request has been received, the process proceeds to Step S27, and when determined that no additional request has been received, the process proceeds to Step S28.

In Step S27, the device for inspection update unit 107 updates the device list for inspection by adding the additional device for inspection transmitted from the additional device for inspection extraction unit 112 to the device list for inspection. Thereafter, the process returns to Step S23. In Step S23, based on the plant structure information and the updated device list for inspection, the route generation unit 108 generates the inspection route (the example of the second inspection route) that passes through the uninspected device subject to inspection and the additional device for inspection listed on the updated device list for inspection.

In Step S28, the device for inspection update unit 107 determines whether or not the device subject to inspection is on the device list for inspection. When determined that a device subject to inspection is on the device list for inspection, the process returns to Step S25, and when determined that no device subject to inspection is on the device list for inspection, the process in FIG. 9 ends.

### <Measurement Diagnostic Unit 111>

The measurement diagnostic unit 111 diagnoses whether any of the plurality of devices subject to inspection are devices with abnormality based on the inspection result received by the communication unit 109.

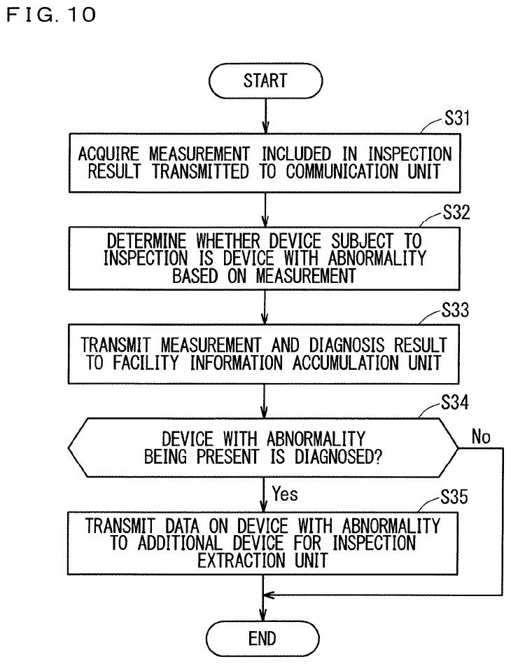

FIG. 10 is a flowchart illustrating a processing procedure for diagnosing abnormality of a device subject to inspection by the measurement diagnostic unit 111 according to Embodiment 1. The flowchart corresponds to the process of Step 7 in FIG. 2.

First, in Step S31, the measurement diagnostic unit 111 acquires a measurement included in the inspection result transmitted from the interface device 110 to the communication unit 109.

In Step S32, the measurement diagnostic unit 111 diagnoses whether the device subject to inspection is a device with abnormality based on the measurement. For example, the measurement diagnostic unit 111 diagnoses that the device subject to inspection is a device with abnormality when the measurement deviates from a normal value range predetermined for each inspection item.

In Step S33, the measurement diagnostic unit 111 transmits the measurement and the diagnosis result to the facility information accumulation unit 103. Note that the measurement diagnostic unit 111 may transmit the measurement and the diagnosis result to the route construction unit 104, and the device for inspection update unit 107 of the route construction unit 104 may add the device whose measurement and diagnosis result has been transmitted from the measurement diagnostic unit 11 to the device list for inspection.

In Step S34, the measurement diagnostic unit 111 determines whether or not the diagnosis in Step S32 is that a device with abnormality is present. When determined that the presence of a device with abnormality has been diagnosed, the process proceeds to Step S35, and when determined that no presence of a device with abnormality has been diagnosed, the process in FIG. 10 ends.

In Step S35, the measurement diagnostic unit 111 transmits data on device with abnormality to the additional device for inspection extraction unit 112. Then, the process of FIG. 10 ends.

### <Additional Device for Inspection Extraction Unit 112>

The additional device for inspection extraction unit 112 includes the related device extraction unit 113, the related degree calculation unit 114, and the additional device for inspection determination unit 115.

The related device extraction unit 113 extracts one or more related devices related to the device with abnormality from a plurality of devices in the plant based on the related information. In Embodiment 1, as described above, the information in the device subject to monitoring information accumulation unit 102 and the information in the facility information accumulation unit 103 are used as the related information. Regarding the device subject to monitoring, the monitoring control information acquired by the monitoring control device 101 and accumulated in the device subject to monitoring information accumulation unit 102 is used as the related information.

The related device extraction unit 113 according to Embodiment 1 compares the data on the device with abnormality received from the measurement diagnostic unit Ill to the data on all devices in the plant, and extracts a device having even one item that are the same or similar to the device with abnormality as a related device. For example, when the device A in FIG. 4 represents the device with abnormality, the related device extraction unit 113 extracts all devices including devices whose the manufacturer is ∘∘ Electric, devices whose the type is transformer, devices whose dates of installation are close to each other (for example, devices whose dates of installation are from Mar. 5, 2017 to May 4, 2017, being one month before or after the date of installation of the device A, or are from Oct. 5, 2016 to Oct. 5, 2017, being six months before or after the date of installation of the device A, or the like), devices whose failure histories are similarly close to each other, or the like.

Note that the related device extraction unit 113 may use data on the connection relationship of devices indicating the physical connection relationship as the related information. According to such a configuration, devices that have a connection relationship with the device with abnormality can be extracted as related devices.

Also, the related device extraction unit 113 may use data on the operation histories of a plurality of devices subject to monitoring included in the monitoring control information acquired by the monitoring control device 101, as the related information. According to such a configuration, devices that operate in a connection time zone with the device with abnormality can be extracted as related devices.

Also, the related device extraction unit 113 may use data on dependencies between signals of the plurality of devices subject to monitoring included in the monitoring control information acquired by the monitoring control device 101, as the related information. According to such a configuration, for example, in a facility that uses signals from two devices to issue an alert, when one device is diagnosed as a device with abnormality, the other device can be extracted as a related device.

The related degree calculation unit 114 calculates a related degree between the device with abnormality and one or more related devices extracted by the related device extraction unit 113 based on the related information. For example, of the facility information held in the facility information accumulation unit 103, facility information regarding the device with abnormality and facility information regarding the related device are used as the related information for calculating the related degree. For example, to each item of data for each device, the related degree calculation unit 114 assigns “I” if it matches the device with abnormality, and “0” if it does not match the device with abnormality, and calculates the total score obtained by adding up the scores of all items of each device as the related degree between the device with abnormality and each device.

As a specific example, assume that the device A represents the device with abnormality in FIGS. 3 and 4, and the device B represents the related devices B and C. The facility information for the device B is as follows: Manufacturer ∘∘ Electric, Type: Switch, Device Connection Relationship: AAA001, Date of Installation: Apr. 4, 2017, Failure History: None, Operation History: Apr. 5, 2107, . . . The facility information for the device C is as follows: Manufacturer: ΔΔ plant, Type: Transformer, Device Connection Relationship; AAA005, Date of Installation: Oct. 1, 2017, Failure History: Apr. 20, 2020, Operation History: Oct. 15, 2017, . . . The dates are to be determined as a match when the date difference is within one month, and all items not specified above are to be determined as a mismatch.

In this example, due to the device B matching the device A in terms of the items Manufacturer, Device Connection Relationship, Date of Installation, and Operation History, the related degree of the device B is 4. Due to the device C matching the device A in terms of the items Type and Failure History, the related degree of the device C is 2.

Note that the calculation of the related degree by the related degree calculation unit 114 is not limited to the above. For example, the related degree calculation unit 114 may change the related degree based on weighting set in advance for each item, or change the related degree based on the difference between each period for the device with abnormality and each period for the related device. That is, the related degree calculation unit 114 may be configured to correct the related degree based on the items and the numerical values. In addition, similar to the related device extraction unit 113, the related degree calculation unit 114 calculates the related degree based on at least one of the operating history data or the dependency data included in the monitoring control information acquired by the monitoring control device 101.

The additional device for inspection determination unit 115 determines whether or not to extract an additional device for inspection from the one or more related devices based on the related degree of the one or more related devices calculated by the related degree calculation unit 114. As a determination method by the additional device for inspection determination unit 115, a method of determining whether or not the related degree is equal to or greater than a preset threshold is conceivable. For example, when the preset threshold is set to 3, that is, when the related devices with the related degree of 3 or higher are extracted as additional devices for inspection, in the above example, the device C is not extracted as an additional device for inspection, but the device B is extracted as an additional device for inspection.

Note that the determination method by the additional device for inspection determination unit 115 is not limited to the above. For example, the additional device for inspection determination unit 115 may determine that all related devices with the related degree of within the top 10 are extracted as additional devices for inspection, and as in Embodiment 5, may determine that the related devices whose related degree is selected by the inspector are to be extracted as additional devices for inspection.

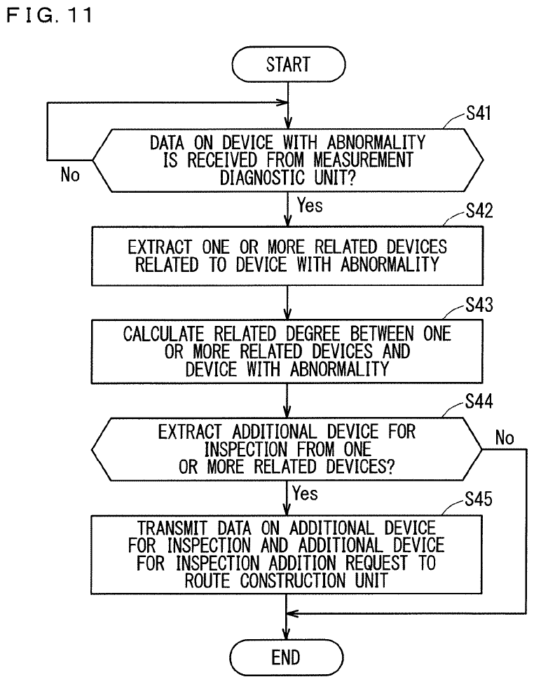

FIG. 11 is a flowchart illustrating a processing procedure for extracting an additional device for inspection by the additional device for inspection extraction unit 112 according to Embodiment 1. The flowchart corresponds to the process of Step 9 in FIG. 2. Note that the process of extracting the additional device for inspection of FIG. 11 is executed every time it is diagnosed that a device with abnormality is present.

In Step S41, the related device extraction unit 113 determines whether or not data on device with abnormality is received from the measurement diagnostic unit 111. When determined that data on the device with abnormality has been received, the process proceeds to Step S42, and when determined that the data on the device with abnormality has not been received, the process of Step S41 is re-performed.

In Step S42, the related device extraction unit 113 extracts one or more related devices related to the device with abnormality based on the related information.

In Step S43, the related degree calculation unit 114 calculates the related degree between one or more related devices and the device with abnormality.

In Step S44, the additional device for inspection determination unit 115 determines whether or not to extract an additional device for inspection from the one or more related devices based on the related degree of the one or more related devices calculated in Step S43. When determined that an additional device for inspection is extracted from one or more related devices, the process proceeds to Step S45, when determined that an additional device for inspection is not extracted from one or more related devices, the process in FIG. 11 ends.

In Step S45, the additional device for inspection determination unit 115 transmits data on the additional device for inspection and an addition request to the route construction unit 104. Then, the process of FIG. 11 ends.

### <Hardware Configuration>

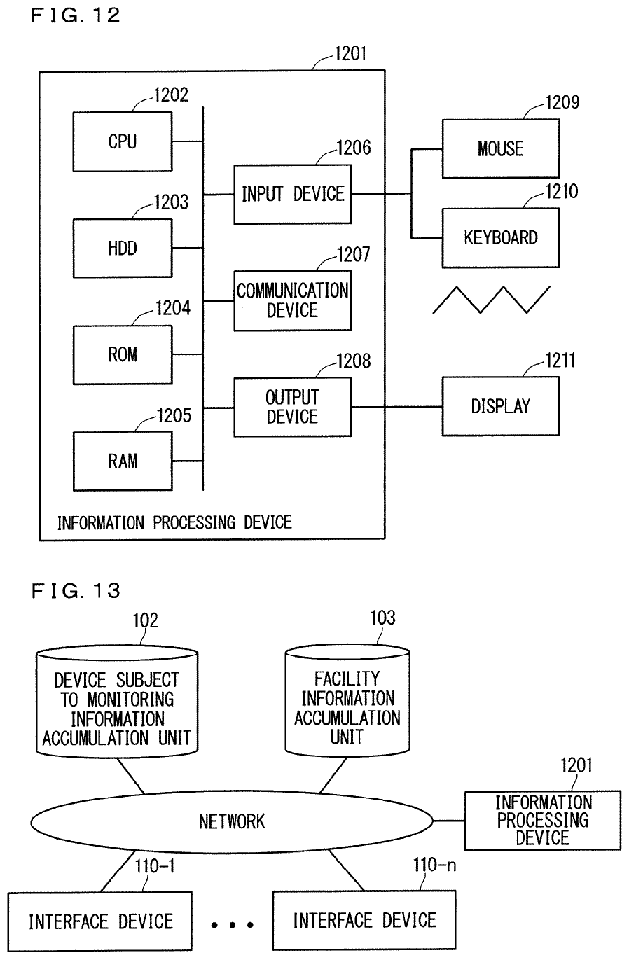

FIG. 12 is a block diagram illustrating a hardware configuration of an information processing device 1201 for implementing a part of the inspection work assistance apparatus according to Embodiment 1. The information processing device 1201 is hardware that implements the route construction unit 104, the communication unit 109, the measurement diagnostic unit 111, and the additional device for inspection extraction unit 112. The information processing device 1201 in FIG. 12 includes a Central Processing Unit (CPU) 1202, a Hard Disc Drive (HDD) 1203, a Read Only Memory (ROM) 1204, a Random Access Memory (RAM) 1205, an input device 1206, a communication device 1207, an output device 1208, a mouse 1209, a keyboard 1210, and a display 1211. The route construction unit 104, the measurement diagnostic unit 111, and the additional device for inspection extraction unit 112 are implemented by the hardware of the CPU 1202, the HDD 1203, the ROM 1204, and the RAM 1205 cooperating with software such as a control program that controls the operation of the inspection work assistance apparatus. The communication unit 109 is implemented by the communication device 1207.

### <Network Configuration>

FIG. 13 is a block diagram illustrating a network configuration for implementing the inspection work assistance apparatus according to Embodiment 1. As illustrated in FIG. 13, the information processing device 1201 in FIG. 12 is connected to the device subject to monitoring information accumulation unit 102, the facility information accumulation unit 103, and one or more interface devices 110-1 to 110-n via a network. Note that the device subject to monitoring information accumulation unit 102 and the facility information accumulation unit 103 may be implemented by the HDD 1203 of the information processing device 1201, and the plant structure information accumulation unit 105 of the route construction unit 104 may be connected to the information processing device 1201 via the network. Further, one or more of the interface devices 110-1 to 110-n may be connected to the information processing device 1201 by wireless communication using, for example, 4G and Bluetooth (registered trademark).

Although the hardware for implementing the inspection work assistance apparatus according to Embodiment 1 has been described above, the same applies to the inspection work assistance apparatuses according to other embodiments such as Embodiment 2.

### Summary of Embodiment 1

The inspection work assistance apparatus according to above Embodiment 1 extracts an additional device for inspection related to the device with abnormality from the plurality of devices in the plant when a device with abnormality is present, and creates an inspection route (an example of a second inspection route) that passes through at least one of the plurality of devices subject to inspection and the additional device for inspection. According to such a configuration, an inspection can be conducted in which abnormalities in an additional device for inspection, which has a relatively high potential of abnormality occurrence, are found at early stage, and the inspection can be efficiently conducted using the inspection route that includes the additional device for inspection, enabling appropriate assistance for inspection work.

### Modification

In Embodiment 1, the inspection work assistance apparatus may create a new second inspection route by creating the second inspection route and then using the created second inspection route as the first inspection route. According to such a configuration, changes in devices for inspection can be flexibly responded.

### Embodiment 2

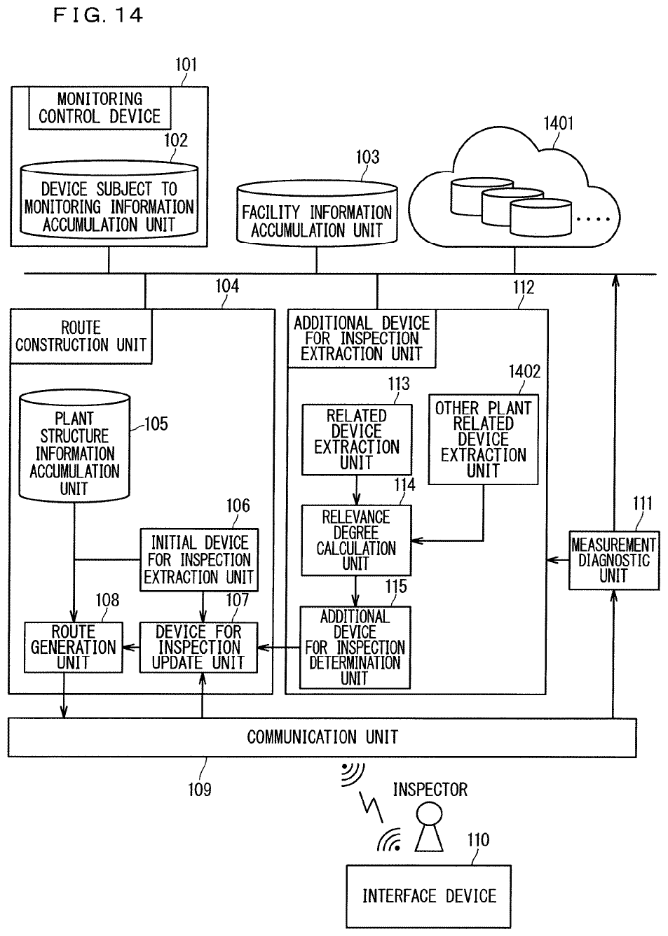

FIG. 14 is a block diagram illustrating a configuration of an inspection work assistance apparatus according to Embodiment 2. Hereinafter, of the components according to Embodiment 2, the same or similar reference numerals are given to the same or similar components as those described above, and different components will be mainly described.

The configuration in FIG. 14 is similar to the configuration in FIG. 1 with the addition of a device information accumulation unit 1401 and an other plant related device extraction unit 1402.

The device information accumulation unit 1401 accumulates not only integrated information that integrates the information in the device subject to monitoring information accumulation unit 102 and the facility information accumulation unit 103 of its own plant, but also integrated information that integrates information in a device subject to monitoring information accumulation unit and a facility information accumulation unit of an other plant. The other plant corresponds to the own plant, and a plurality of devices of the other plant and the plurality of devices of the own plant are the same or similar.

Here, in Embodiment 1, the information in the device subject to monitoring information accumulation unit 102 and the facility information accumulation unit 103 of the own plant is used as related information that allows the plurality of devices in the own plant to be related. In addition to this, in Embodiment 2, the integrated information that integrates the information in the device subject to monitoring information accumulation unit and the facility information accumulation unit of the other plant is used as the other related information that allows the plurality of devices in the other plant to be related. The other related information is the same as the related information except for the difference between the own plant and the other plant.

In the own plant, the device subject to monitoring information accumulation unit 102, the facility information accumulation unit 103, and the additional device for inspection extraction unit 112 may be connected via a network, or a cloud form them may be used. The other plant may also be connected in the same manner, and all plants may be able to access each other.

The additional device for inspection extraction unit 112 includes the other plant related device extraction unit 1402 in addition to the components of Embodiment 1. The other plant related device extraction unit 1402 extracts a related device to be an additional device for inspection based on the other related information of the other plant from the device information accumulation unit 1401. The additional device for inspection extraction unit 112 can extract a device, which could not be extracted using the related information of the own plant alone, as an additional device for inspection by using the other related information of the other plant.

For example, the other plant related device extraction unit 1402 determines whether or not a first other device of the other plant is present that is operated in the same manner as the device with abnormality of the own plant, based on the information in the device information accumulation unit 1401. When determined that the first other device is present, the other plant related device extraction unit 1402 extracts a second other device being related to the first other device and having an abnormality within a certain period of time from the current point of time (for example, within one year) from a plurality of devices in the other plant based on the other related information. Then, based on the information in the device information accumulation unit 1401, the other plant related device extraction unit 1402 extracts a device of the own plant that is operated in the same manner as the second other device extracted by the other plant related device extraction unit 1402 as a related device to be an additional device for inspection. The underlying theory of the extraction is that the presence of an abnormality in the past in the second other device related to the first other device, which is operated in the same manner as the device with abnormality, indicates the probability of the possible presence of an abnormality in the device of the own plant that is operated in the same manner as the second other device.

For example, when an abnormality is present in a device A in the own plant, the other plant related device extraction unit 1402 extracts a device B (an example of the first other device) that is operated in the same manner as the device A, which is the device with abnormality, from the plurality of devices of the other plant based on the information in the device information accumulation unit 1401. Based on the other related information, the other plant related device extraction unit 1402 extracts a device C (an example of the second other device) that is related to the device B and has an abnormality within one year from the plurality of devices in the other plant. Based on the information in the device information accumulation unit 1401, the other plant related device extraction unit 1402 extracts a device D corresponding to the device C from the plurality of devices of the own plant as a related device to be an additional device for inspection.

The related degree calculation unit 114 does not calculate the related degree for the related device extracted by the other plant related device extraction unit 1402, and assigns the related degree with which the related device is unconditionally determined as the additional device for inspection by the additional device for inspection determination unit 115.

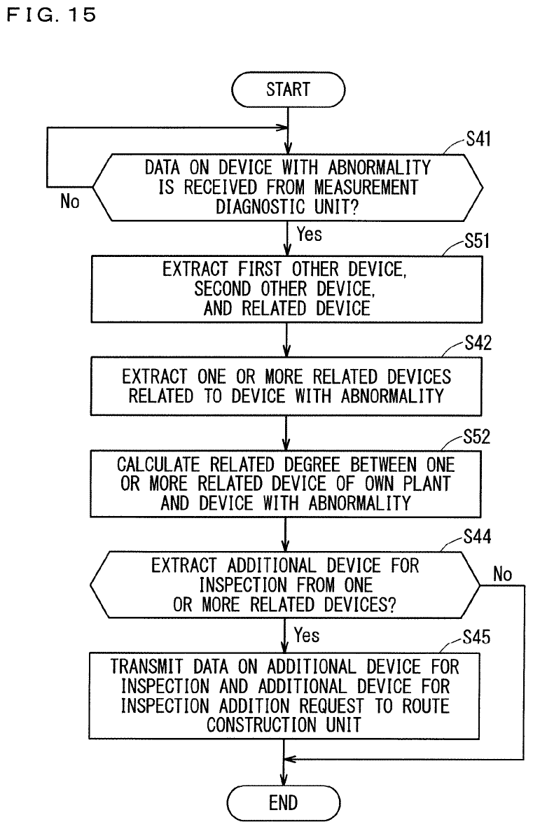

FIG. 15 is a flowchart illustrating a processing procedure for extracting an additional device for inspection by the additional device for inspection extraction unit 112 according to Embodiment 2. The flowchart in FIG. 15 corresponds to the flowchart in FIG. 11. Hereinafter, among the processes in FIG. 15, Steps S51 and S52, which are different from the processes in FIG. 11, will be mainly described.

In Step S51 that comes after Step S41, the other plant related device extraction unit 1402 extracts the first other device and the second other device, and extracts the device of the own plant that is operated in the same manner as the second other device as a related device to be the additional device for inspection.

After Step S51, Step S42 and Step S52 are performed in this order. In Step S52, the related degree calculation unit 114 does not calculate the related degree for the related device extracted in Step S51, and assigns the related degree with which the related device extracted in Step S51 is unconditionally determined as the additional device for inspection by the additional device for inspection determination unit 115. Meanwhile, the related degree calculation unit 114 calculates the related degree for one or more related devices extracted in Step S42 in the same manner as in Embodiment 1. Then, as in Embodiment 1, the processes from Step S44 onward are performed.

### Summary of Embodiment 2

According to the inspection work assistance apparatus according to Embodiment 2 as described above, the other related information of the other plant is used to extract an additional device for inspection. According to such a configuration, a device, which could not be extracted using the related information of the own plant alone, can be extracted as an additional device for inspection. This enables to extract a device with the probability of the possible presence of abnormality as an additional device for inspection.

### Embodiment 3

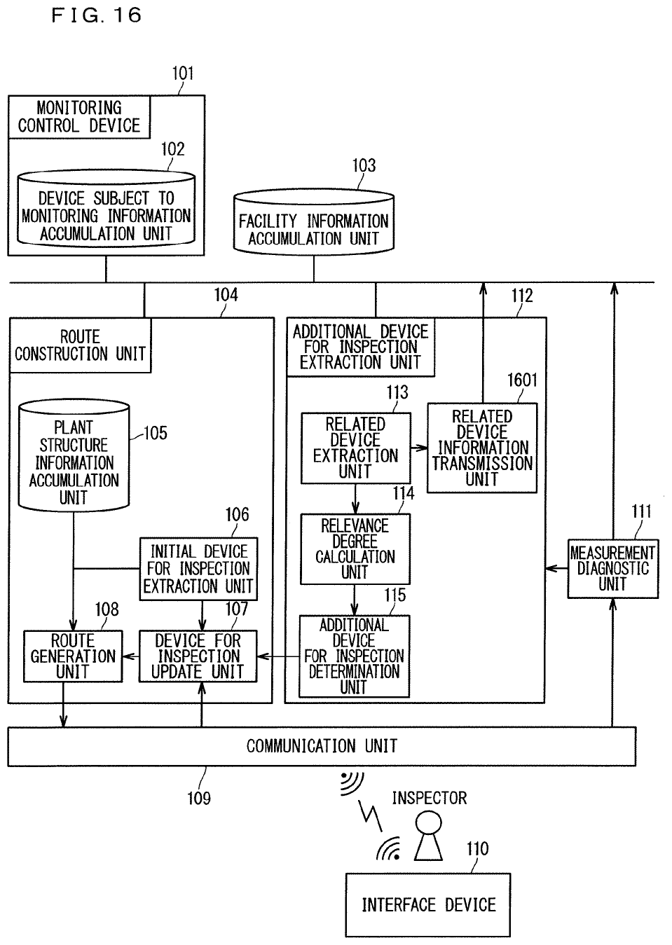

FIG. 16 is a block diagram illustrating a configuration of an inspection work assistance apparatus according to Embodiment 3. Hereinafter, of the components according to Embodiment 3, the same or similar reference numerals are given to the same or similar components as those described above, and different components will be mainly described.

The configuration in FIG. 16 is similar to the configuration in FIG. 1 with the addition of a related device information transmission unit 1601.

In Embodiment 3, a plurality of devices subject to inspection include a first device subject to inspection and a second device subject to inspection. Although each of the first device subject to inspection and the second device subject to inspection may be any device subject to inspection, in the following description, the first device subject to inspection is assumed to be a device of which related device has been extracted by the related device extraction unit 113 of the additional device for inspection extraction unit 112. Note that a device extracted by the related device extraction unit 113 and related to the first device subject to inspection will be referred to as an inspection related device hereinafter.

The related device information transmission unit 1601 transmits data on the inspection related device extracted by the related device extraction unit 113 to the facility information accumulation unit 103 and accumulates it in the facility information accumulation unit 103. The data on inspection related device accumulated in the facility information accumulation unit 103 is updated every time the related device extraction unit 113 performs extraction.

The initial device for inspection extraction unit 106 acquires the data on inspection related device accumulated in the facility information accumulation unit 103. Then, when the inspection related device and the second device subject to inspection are the same, the initial device for inspection extraction unit 106 deletes any of the first device subject to inspection and the second device subject to inspection from the plurality of devices subject to inspection listed on the initial device list for inspection.

For example, the initial device for inspection extraction unit 106 may delete the device whose time period between the most recent inspection and the current point in the inspection history is shorter among the first device subject to inspection and the second device subject to inspection. Accordingly, of the first device subject to inspection and the second device subject to inspection, the inspection of the device having the longer time between the most recent inspection and the current time in the inspection history can be conducted.

Also, for example, the initial device for inspection extraction unit 106 may delete any of the first device subject to inspection and the second device subject to inspection based on the biometric information of the inspector who conducted the inspection of the first device subject to inspection and the second device subject to inspection. This allows the inspector to inspect a device subject to inspection that is suitable for this person.

Based on the information in the plant structure information accumulation unit 105 and the initial device list for inspection from which any of the first device subject to inspection and the second device subject to inspection is deleted, the route generation unit 108 generates an inspection route (an example of the first inspection route). That is, the initial device for inspection extraction unit 106 of the route construction unit 104 generates an inspection route after deleting a plurality of devices subject to inspection. Note that the initial device for inspection extraction unit 106 may be configured to restore either the deleted first device subject to inspection or the second device subject to inspection to the device list for inspection when an abnormality is detected in the uninspected device subject to inspection remaining in the device list for inspection.

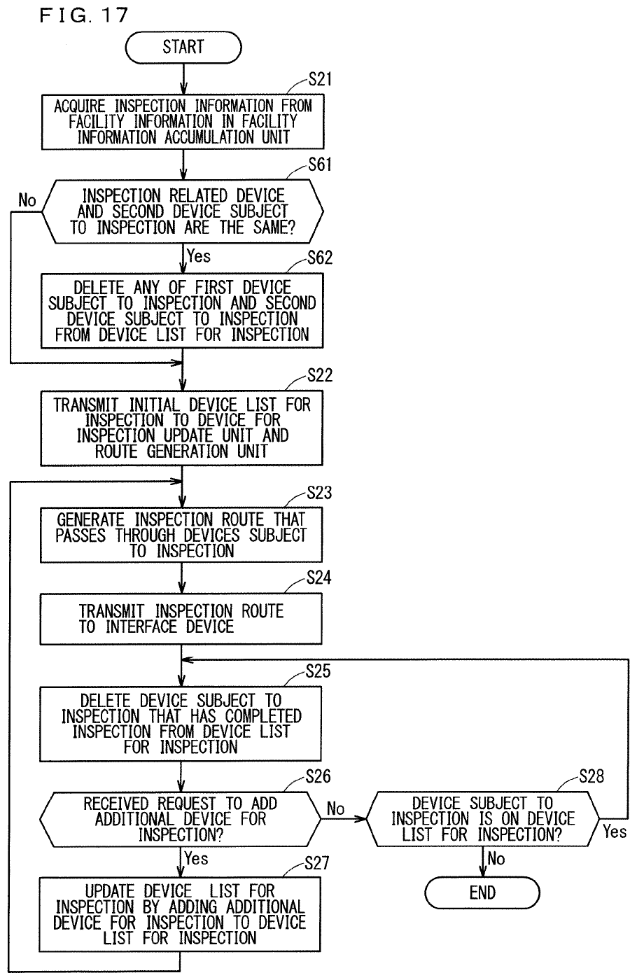

FIG. 17 is a flowchart illustrating a processing procedure to create the inspection route by the route construction unit 104 according to Embodiment 3. The flowchart in FIG. 17 corresponds to the flowchart in FIG. 9. Hereinafter, among the processes in FIG. 17, Steps S61 and S62, which are added between Step S21 and Step S23 in FIG. 9, will be mainly described.

In Step S61 that comes after Step S21, the initial device for inspection extraction unit 106 acquires the data on inspection related device accumulated in the facility information accumulation unit 103. Then, the initial device for inspection extraction unit 106 determines whether or not the inspection related device and the second device subject to inspection are the same. This substantially determines whether the first device subject to inspection and the second device subject to inspection are related to each other. When determined that the inspection related device and the second device subject to inspection are the same, the process proceeds to Step S62, and when determined that the inspection related device and the second device subject to inspection are different from each other, the process proceeds to Step S23.

In Step S62, the initial device for inspection extraction unit 106 deletes any of the first device subject to inspection and the second device subject to inspection from the plurality of devices subject to inspection listed on the device list for inspection. Then, as in Embodiment 1, the processes from Step S22 onward are performed.

### Summary of Embodiment 3

According to the inspection work assistance apparatus according to Embodiment 3 as described above, when the inspection related device related to the first device subject to inspection and the second device subject to inspection are the same, any of the first device subject to inspection and the second device subject to inspection is deleted from the plurality of devices subject to inspection through which the inspection route is to pass. According to such a configuration, inspection can be efficiently conducted in a case where inspection of one of the first device subject to inspection and the second device subject to inspection that are related to each other eliminates the need to inspect the other.

### Embodiment 4

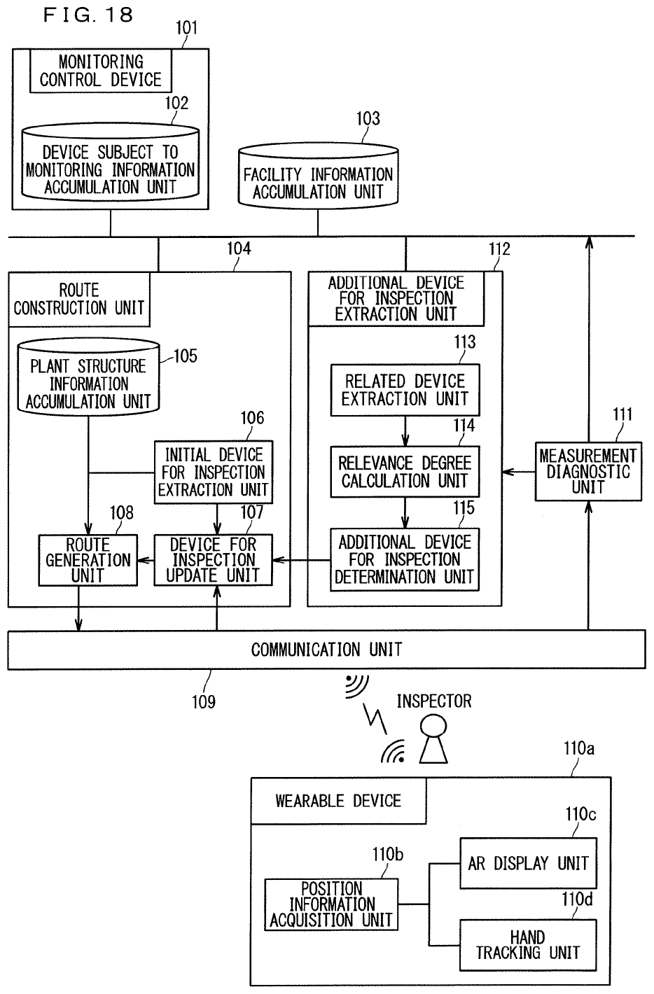

FIG. 18 is a block diagram illustrating a configuration of an inspection work assistance apparatus according to Embodiment 4. Hereinafter, of the components according to Embodiment 4, the same or similar reference numerals are given to the same or similar components as those described above, and different components will be mainly described.

In Embodiment 4, the interface device 110 described in Embodiment 1 is represented by a wearable device 110a such as a Head Mounted Display (HMD) used by an inspector who conducts inspection work. The wearable device 110a includes a position information acquisition unit 110b which is a position acquisition unit, an augmented reality display unit (hereinafter referred to as AR display unit) 110c, and a hand tracking unit 110d.

The position information acquisition unit 110b acquires position information indicating the current position of the wearable device 110a held by the inspector. The position information acquisition unit 110b may acquire position information through communication with GPS, or may acquire position information through communication with beacons installed within the plant. Note that the configuration of the position information acquisition unit 110b that acquires the position information is not limited thereto.

The AR display unit 110c displays various types of information in the field of view of the inspector in AR. For example, the AR display unit 110c displays inspection procedures for devices on the display of the wearable device 110a. Also, for example, based on the position acquired by the position information acquisition unit 110b, the AR display unit 110c displays an inspection route (for example, at least one of the first inspection route or the second inspection route) by superimposing the route on a passage, devices, etc. within the field of view. Displaying in AR may be implemented by displaying a marker superimposed on a device, or by changing the display based on GPS or an acceleration sensor, or the like, and implementation method is not limited to these.

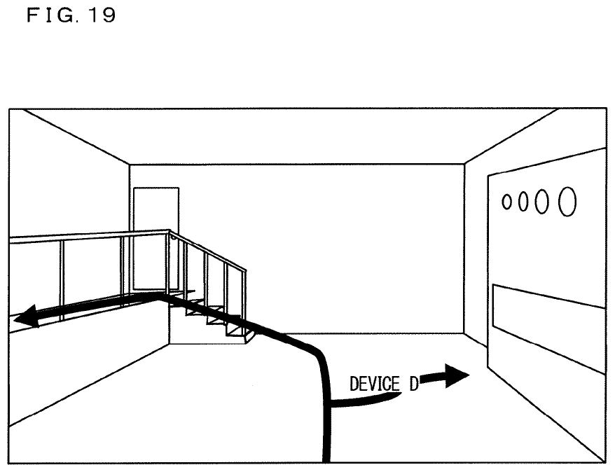

FIG. 19 is a diagram illustrating a display example of the AR display unit 110c. The example of FIG. 19 illustrates a state seen by the inspector when the inspection route is superimposed on the passage within the field of view of the inspector. The AR display unit 110c displays arrows representing an inspection way as the inspection route. When a device subject to inspection is present on the inspection route, the AR display unit 110c additionally displays information such as the name of the device subject to inspection and an arrow pointing to the position of the device subject to inspection.

The hand tracking unit 110d detects (acquires) the movement of the inspector's hand within the display range of the AR display unit 110c. As an alternative to a tablet, the hand tracking unit 110d detects an input of the inspection result from the inspector, operation of the inspection procedure of the device displayed within the display range, and the like. This eliminates the need for inspectors to hold an input terminal such as a tablet during inspection.

### Summary of Embodiment 4

According to the inspection work assistance apparatus according to Embodiment 4 as described above, the wearable device 110a is adopted. According to such a configuration, by displaying the current position within the field of view by grasping the position information, intuitively grasping the inspection route displayed in AR, and inputting the inspection result by the hand tracking unit 110d, safety and the operation efficiency of the entire inspection work can be improved.

### Embodiment 5

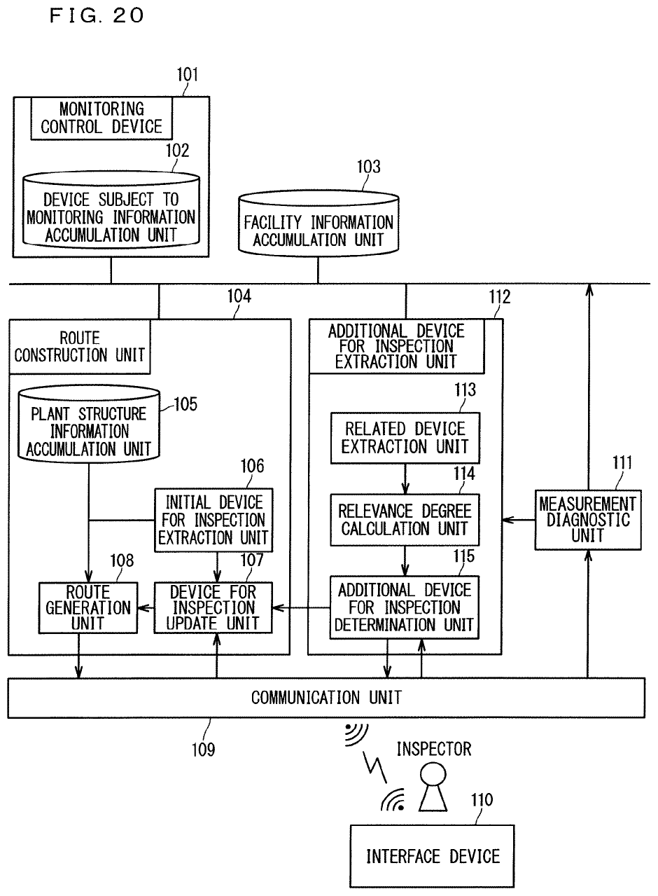

FIG. 20 is a block diagram illustrating a configuration of an inspection work assistance apparatus according to Embodiment 5. Hereinafter, of the components according to Embodiment 5, the same or similar reference numerals are given to the same or similar components as those described above, and different components will be mainly described.

In Embodiment 1, the additional device for inspection extraction unit 112 determines whether or not to extract an additional device for inspection from the one or more related devices based on the related degree of the one or more related devices. Whereas, in Embodiment 5, the interface device 110 displays one or more related devices and related degrees thereof to the user, and acquires the related device selected by the user from the one or more related devices. The user who makes the selection may be an inspector, a supervisor who monitors in a monitoring control room, or the like, or any person who can select a related device as an additional device for inspection. Here, the description will be made assuming that the user is an inspector.

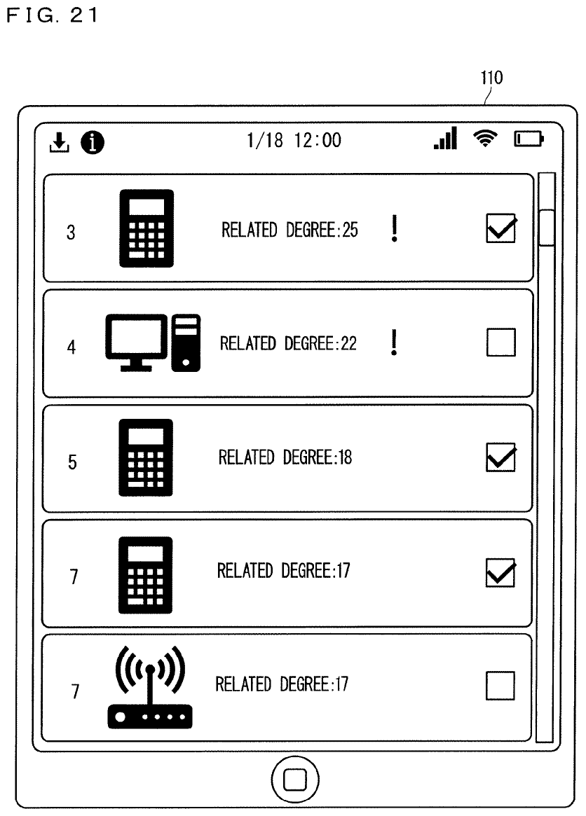

FIG. 21 is an example of a display screen of the interface device 110. Such a display is implemented by the additional device for inspection determination unit 115 transmitting information such as the related degree calculated by the related degree calculation unit 114 to the interface device 110 held by the inspector via the communication unit 109. The display screen in FIG. 21 displays information including the one or more related devices and the related degrees calculated by the related degree calculation unit 114. Note that a related device with a high related degree (for example, all related devices with the related degrees within the top 20) may be highlighted. Based on this information, the inspector selects a related device as an additional device for inspection.

The interface device 110 acquires the related device selected by the inspector and transmits it to the communication unit 109. The additional device for inspection determination unit 115 determines to extract the related device transmitted to the communication unit 109 as an additional device for inspection. Accordingly, the additional device for inspection extraction unit 112 extracts the related device acquired by the interface device 110 as an additional device for inspection, and transmits it to the device for inspection update unit 107. The device for inspection update unit 107 adds the received additional device for inspection to the device list for inspection.

### Summary of Embodiment 5

According to the inspection work assistance apparatus according to Embodiment 5 as described above, a user such as an inspector can select a related device for inspection from one or more related devices, so that on-site judgment additional inspections can be implemented.

Note that the interface device 110 may be a wearable device 110a as in Embodiment 4. Further, the inspection work assistance apparatus may have one of the determination function based on the related degree by the additional device for inspection determination unit 115 described in Embodiment 1 and the acquisition function with the user selection described in Embodiment 5, or may have both in a switchable manner.

It should be noted that Embodiments and Modifications can be arbitrarily combined and can be appropriately modified or omitted.

The forgoing description is in all aspects illustrative and not restrictive. It is therefore understood that numerous undescribed Modifications can be devised.

### EXPLANATION OF REFERENCE SIGNS

101 monitoring control device, 104 route construction unit, 105 plant structure information accumulation unit, 106 initial device for inspection extraction unit, 107 device for inspection update unit, 108 route generation unit, 109 communication unit, 110 interface device, 110a wearable device, 110b position information acquisition unit, 110a AR display unit, 110d hand tracking unit, 111 measurement diagnostic unit, 112 additional device for inspection extraction unit, 113 related device extraction unit, 114 related degree calculation unit, 115 additional device for inspection determination unit.

1. An inspection work assistance apparatus configured to assist inspection work in a plant, comprising:
an acquisition circuitry configured to acquire an inspection result of any of a plurality of devices subject to inspection through which a first inspection route passes among a plurality of devices in the plant;
a determination circuitry configured to determine whether any of the plurality of devices subject to inspection is a device with abnormality based on the inspection result;
an extraction circuitry configured to extract an additional device for inspection related to the device with abnormality from the plurality of devices in the plant based on other related information that allows a plurality of device information in an other plant corresponding to the plant to be related; and
a route creation circuitry configured to create a second inspection route passing through at least one of the plurality of devices subject to inspection and the additional device for inspection.

2.-5. (canceled)

6. The inspection work assistance apparatus according to claim 1, wherein
the plurality of devices subject to inspection include a first device subject to inspection and a second device subject to inspection,
the extraction circuitry is configured to extract an inspection related device related to the first device subject to inspection from the plurality of devices based on the related information that allows the plurality of devices to be related, and,
when the inspection related device and the second device subject to inspection are the same, the route creation circuitry is configured to, delete any of the first device subject to inspection and the second device subject to inspection from the plurality of devices subject to inspection through which the first inspection route is to pass.

7. The inspection work assistance apparatus according to claim 1, further comprising
a wearable device used by an inspector who performs the inspection work, wherein
the wearable device includes
a position acquisition circuitry configured to acquire a position of the wearable device,
an augmented reality display circuitry configured to display at least one of the first inspection route or the second inspection route based on the position acquired by the position acquisition circuitry, and
a hand tracking circuitry configured to acquire hand movements of the inspector in a display range of the augmented reality display circuitry.

8. (canceled)

9. An inspection work assistance method configured to assist inspection work in a plant, comprising:
acquiring an inspection result of any of a plurality of devices subject to inspection through which a first inspection route passes among a plurality of devices in the plant;
determining whether any of the plurality of devices subject to inspection is a device with abnormality based on the inspection result;
extracting an additional device for inspection related to the device with abnormality from the plurality of devices in the plant based on other related information that allows a plurality of device information in an other plant corresponding to the plant to be related; and
creating a second inspection route passing through at least one of the plurality of devices subject to inspection and the additional device for inspection.

10. The inspection work assistance method according to claim 9, wherein
the additional device for inspection is extracted based on related information that allows the plurality of devices to be related and the other related information.

11. The inspection work assistance apparatus according to claim 1, wherein
the extraction circuitry is configured to extract the additional device for inspection based on related information that allows the plurality of devices to be related and the other related information.

12. An inspection work assistance apparatus configured to assist inspection work in a plant, comprising:
an acquisition circuitry configured to acquire an inspection result of any of a plurality of devices subject to inspection through which a first inspection route passes among a plurality of devices in the plan;
a determination circuitry configured to determine whether any of the plurality of devices subject to inspection is a device with abnormality based on the inspection result;
an extraction circuitry configured to extract an additional device for inspection related to the device with abnormality from the plurality of devices based on related information that allows the plurality of devices to be related; and
a route creation circuitry configured to create a second inspection route passing through at least one of the plurality of devices subject to inspection and the additional device for inspection, wherein
the plurality of devices subject to inspection include a first device subject to inspection and a second device subject to inspection,
the extraction circuitry is configured to extract an inspection related device related to the first device subject to inspection from the plurality of devices based on the related information, and
when the inspection related device and the second device subject to inspection are the same, the route creation circuitry is configured to, delete any of the first device subject to inspection and the second device subject to inspection from the plurality of devices subject to inspection through which the first inspection route is to pass.
